(19) United States
(12) Patent Application Publication
(10) Pub. No.: US 2003/0063069 A1
(43) Pub. Date: Apr. 3, 2003

(54) Method and apparatus for correlating a computer screen, computer keyboard keys, and a user's finger to enhance operation of a computer

(76) Inventor: Elizabeth A. Myers, Phoenix, AZ (US)

Correspondence Address: TOD R. NISSLE, P.C., P.O. Box 55630, Phoenix, AZ, 85078, US

(21) Appl. No.: 09/969,118

(22) Filed: Oct. 1, 2001

(51) Int. Cl. G09G 5/00

(52) U.S. Cl. 345/168

(57) ABSTRACT

A method and apparatus correlate a computer screen, a computer keyboard, and a user's fingers to enhance operation of a computer. The method and apparatus correlate the home keys on a computer keyboard with a theme that appears on a label attached to the user's fingers.

This invention pertains to computers.

More particularly, this invention pertains to a method and apparatus for correlating a user's fingers with keyboard keys and a visual display on a computer screen to facilitate operation of a computer.

In a further respect, the invention pertains to a method and apparatus for correlating a user's fingers with the home keys on a computer keyboard using a theme which predicates that particular kinds of objects are utilized in conjunction with the home keys and with images that appear on the computer screen.

Various methods and instructions for learning how to operate a computer keyboard are known in the art. Such methods typically focus on describing which ones of a user's fingers are used to depress particular keys on the keyboard. In order to facilitate the learning process, it would be desirable to provide mnemonic methods and apparatus associated with the user's fingers, the keyboard, and the computer display.

Therefore, it is a principal object of the instant invention to provide an improved method and apparatus for learning to use a computer.

A further object of the invention is to provide an improved method and apparatus for correlating a user's fingers, a key board, and a computer display.

These and other, further and more specific objects and advantages of the invention will be apparent from the following detailed description of the invention, taken in conjunction with the drawings, in which:

FIG. 1 is perspective view illustrating a mnemonic apparatus constructed in accordance with the principles of the invention;

FIG. 2 is an perspective view illustrating the mnemonic device of FIG. 1 in combination with apparatus for mounting the device on the top of the finger of a user;

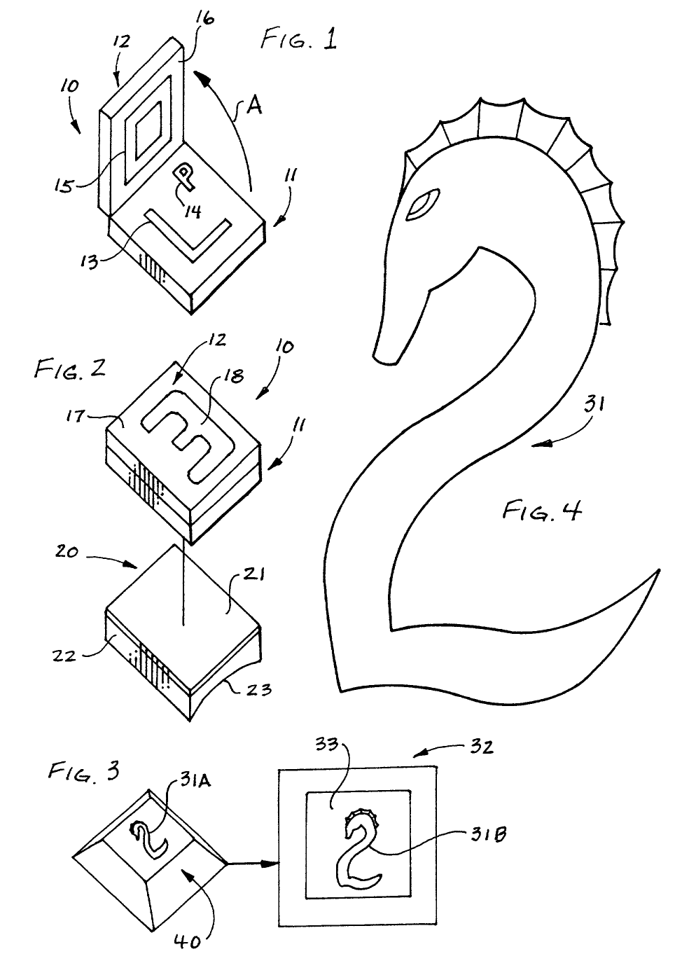

FIG. 3 is a perspective view illustrating the use of a theme to correlate the key of a keyboard with the display of a computer;

FIG. 4 is a front view of a numeral illustrated in accordance with a theme used to correlate a user's finger with the display of a computer;

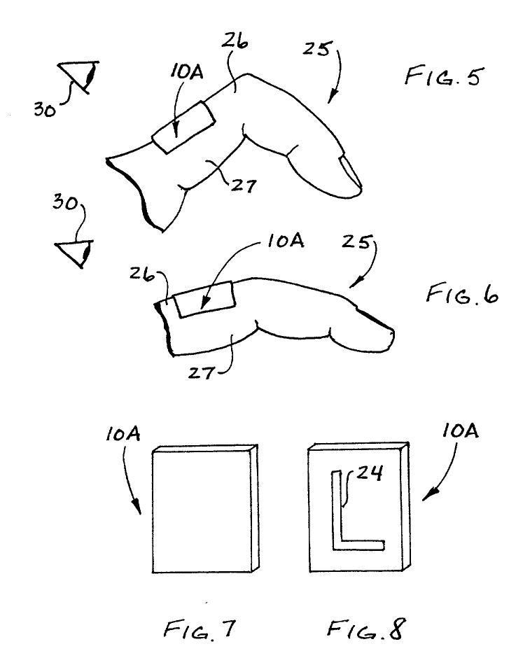

FIG. 5 is a side view illustrating a user's index finger bent to cant a holographic identification label attached to the finger so that a character in the label is visible to the user;

FIG. 6 is a side view illustrating a user's index finger in a relatively straight position which prevents a user from viewing the image in the holographic identification label;

FIG. 7 is a top view illustrating the appearance to a user of the holographic label in FIG. 6; and

FIG. 8 is a top view illustrating the appearance to a user of the holographic label in FIG. 5.

Briefly, in accordance with the invention, I provide an improved method for learning the operation of a computer. The computer includes a keyboard and a visual display operatively associated with the keyboard. The improved method includes the steps of selecting a theme; selecting objects each directly associated with the theme; mounting on each finger of a user's hand a label including a picture of a different alphanumeric character drawn with at least one of the objects integrated with the alphanumeric character. Each of the alphanumeric characters is imprinted on one of the keys of the keyboard. The method also includes the steps of placing each of the user's fingers on the keyboard on the key with the alphanumeric character corresponding to the alphanumeric character drawn on the label on the finger; and, depressing with each finger the key on which the finger is resting to produce on the visual display the alphanumeric character associated with the key.

In another embodiment of the invention, I provide, in combination with a finger of a user, apparatus for learning the operation of a computer. The computer includes a keyboard and a visual display operatively associated with the keyboard. The keyboard includes home keys. The apparatus includes a base; a fastener on the base removably mounting the base on the user's finger; indicia on the base identifying the home key of the selected finger; a cover attached to the base for concealing the indicia from view and having at least two operative positions, a first operative closed position for concealing the indicia from view, and, a second operative open position for exposing the indicia to view.

In a further embodiment of the invention, I provide an improved method for learning the operation of a computer. The computer includes a keyboard and a visual display operatively associated with the keyboard. The improved method includes the steps of removably mounting on each finger of a user first indicia identifying the home key of the selected finger, and second indicia means identifying the selected finger; concealing on each finger the first indicia means from view; placing each of the user's fingers on a key on the keyboard; and, exposing the first indicia on at least one of the fingers to determine if the finger is positioned on the home key associated with the finger.

Turning now to the drawings, which depict the presently preferred embodiments of the invention for the purpose of illustrating the practice thereof and not by way of limitation of the scope of the invention, and in which like reference characters refer to corresponding elements throughout the several views, FIGS. 1 illustrates apparatus 10 for correlating a keyboard, a computer screen operatively associated with the keyboard, and a user's fingers positioned on the keyboard. The apparatus 10 includes a base 11 with indica 13, 14 imprinted or otherwise formed on base 11. As used herein, the term indicia indicates one or more indicium. Indica 13 preferably indicates one of the home keys of a computer keyboard. The home keys of a computer keyboard are the keys that the four fingers of each hand rest on when a person begins to type on the keyboard.

As is well known, there are three rows of letter keys on a computer keyboard. The home keys are located are located in the middle of these three rows. The home key for the little finger of the left hand is the “A” key. The home key for the third finger of the left hand is the “S” key. The home key for the middle finger of the left hand is the “D” key. The home key for the index finger of the left hand is the “F” key. The home key for the index finger of the right hand is the “J” key. The home key for the middle finger of the right hand is the “K” key. The home key for the third finger of the right hand is the “L” key. The home key for the little finger of the right hand is the“;” key.

Indicia 14 indicates a keyboard key positioned above the “L” key.

As used herein, the term alphanumeric characters includes numerals, letters, and punctuation marks found on a computer keyboard.

A fourth row of keys on the computer keyboard is positioned above the three rows of letter keys and includes number keys each labeled with one of the numerals 1 to 0.

Indicia 15 can be formed on the lower surface 16 of cover 12. Cover 12 is attached to base 11 and is movable between at least two operative positions, a first closed operative position (FIG. 2) in which cover 12 conceals indicia 13, 14, 15 and a second open operative position (FIG. 1) in which cover 12 is open and exposes to view indicia 13, 14, 15. In FIG. 1, cover 12 is attached to base 11 by a hinge and is opened by pivoting cover 12 in the direction of arrow A.

Cover 12 includes a top surface 17 (FIG. 2) on which indicia 18 can be formed. Indicia 18 indicates the fingers of a user's hand that apparatus 10 is mounted on. In FIG. 2, indicia 18 indicates apparatus 10 is mounted on the third finger of the right hand, where the third finger is the finger between the little finger (the fourth finger) and the middle finger (the second—and longest—finger). In the practice of the invention, the fingers of each hand can be numbered one to four, or, the fingers of both hands can be collectively numbered from one to eight. The apparatus 10 for the right hand fingers can have one color, and the apparatus 10 for each finger of the left hand can have a color different from the color for the apparatus 10 for the right hand.

Apparatus 10 is mounted on a mounting member 20. Member 20 includes a layer of adhesive 21 on support member 22. Adhesive 21 secures base 20 to apparatus 10. Base 20 includes an arcuate lower surface 23 shaped and dimensioned to contour to and fit on the top of a finger of a user. A layer of adhesive can, if desired, be applied to surface 23 to secure surface 23 to the top of a finger of a user. Or, other means can be utilized to mount base 20 or apparatus 10 on the finger of a user. Base 20 can, for example, be a ring which slides over the finger of a user.

In one embodiment of the invention, apparatus 10 comprises a plastic panel 10A in which a holographic image of at least one indicia 24 is formed. When panel 10A is mounted on the top 26 of a finger 25 when a user is typing, the holographic image permits the user's eye 30 to view the indicia 24 as shown in FIG. 8 when the back 26 of the finger 25 is canted in the manner shown in FIG. 5. When, however, the user's finger 25 is substantially straight in the manner shown in FIG. 6, then the user's eye 30 will still see panel 1OA but indicia 24 will not be visible, as illustrated in FIG. 7. Arcuate panel 1OA may, especially if made from a soft “sticky” plastic, adhere to the top 26 of a finger without the use of adhesive or other fastening means. If desired, however, a fastener can be utilized to maintain removably panel 10A in place on the top 26 of a user's finger.

Plastic panel 10A need not be holographic but can have an alphanumeric character permanently or removably imprinted or otherwise formed thereon. Plastic panel 10A can, if desired, be pliable to facilitate the conforming of panel 10A to the finger of a user.

A particular advantage of a holographic panel 10A is that when a user is typing he cannot see the holographic image in panel 10A. If the user forgets which home key the finger 25 must operate, the user can bend his finger 25 to the orientation shown in FIG. 5 so the user can see and read the holographic image. Instead of bending his finger 25 to the orientation shown in FIG. 5, the user can also simply, while maintaining finger 25 in place on the keyboard, bend forward with his back and head and read the holographic image.

In the practice of the invention, it is preferred, although not necessary, that a theme be selected, and that objects associated with the theme then be selected and integrated into the imprints, drawings, etc. of indicia 13, 14, 15, 18. A theme is a particular subject. The theme can be quite specific or can be more general; but, the theme always limits information relative to the theme to a class of information which is significantly less than the class comprised of all known information. For example, one theme can be the ocean creatures. Another theme can be baseball. Another theme can be World War II. Another theme can be airplanes.

After a theme is selected, one or more objects associated with the theme are selected. If the theme is the ocean, the objects selected can be a sea horse, porpoise, seal, shell, palm tree for South Sea island, polar bear, shark, coral, hurricane, etc. When indicia 13, 14, 15, 18 are drawn or otherwise formed, at least one of the selected objects is integrated with the indicia either by making it part of the indicia or by forming it adjacent the indicia. When part of the indicia, the object is integrated in whole or in part with the indicia. For example, an entire sea horse can be integrated, or only the head of the seahorse can be integrated with the indicia.

When the object is integrated with the indicia, a composite indicia is formed. FIG. 4 illustrates a composite indicia 31 formed by integrating a sea horse with the indicia comprising the numeral 2. To facilitate learning, a composite indicia can be formed 31A on each key 40 of a keyboard (or on base 11) instead of or in addition to the conventional alphanumeric character that normally appears on the key. For example, indicia 31 can be placed and visually appear on the keyboard key 40 which normally shows the number “2” imprinted on the key. When a user is learning to use a computer and computer keyboard, the computer can include a computer program which, when key 40 is depressed, causes a composite indicia 31B equivalent in appearance to indicia 31A (albeit larger or smaller than indicia 31A) to appear on the screen 33 of a monitor 32 so that the user can readily correlate indicia 31B to indicia 31A to confirm to the user the keyboard key that was depressed. The theme associated with indicia 31B and 31A helps the user to remember the keyboard key which is depressed to produce the numeral “2” on the computer screen.

Alternatively, indicia 31A can also be formed or placed on the “S” key instead of or along with the letter “S” when a user is being taught the home key for each finger. Indicia 31A can also be formed on surface 17 of apparatus 10 worn on the third finger of the user's left hand. If indicia 31A is formed on the “S” key and/or on surface 17 of apparatus 10 worn on the third finger of the user's left hand, then when user presses the “S” key the computer program causes indicia 31A to appear on screen 33 to correlate with indicia 31 A on surface 17 and/or on the “S” key to confirm to the user that the “S” key is the home key for the third finger (i.e., the “number two” finger) of the left hand.

When a letter or number 13, 14, 15 formed on a base 11 or on surface 16 is drawn in whole or in part with an object associated with a selected theme (as is the number 2 in FIG. 4), the computer program utilized in connection with apparatus 10 can, when the keyboard key corresponding to letter or number 13, 14, 15 is depressed, cause the appearance of the letter or number 13, 14, 15 that appears on screen 33 when the key is depressed to correspond to the letter or number on base 11 or surface 16. This use of a theme also facilitates a user's remember the key that is depressed in order to select a particular letter (or number) and cause the letter to appear on screen 33.

The letter “O” formed on surface 16 indicates that the letter “O” is above the letter “L” on a computer keyboard. The letter “P” formed on base 11 in FIG. 1, indicates that the letter “P” is above and to the right of the letter “L” on a computer keyboard.

In use, apparatus 10 or 10A is provided for each finger. As used herein, the term finger does not include a thumb. Consequently, each hand has four fingers and one thumb. The apparatus 10 for the little finger of the left hand includes numeral “1” on surface 17 (instead of the numeral “3” shown in FIG. 2) and includes the letter “A” on base 11 (instead of letter “L” shown in FIG. 1). The apparatus 10 for the third finger of the left hand includes numeral “2” on surface 17 (instead of the numeral “3” shown in FIG. 2) and includes the letter “S” on base 11 (instead of the letter “L” shown in FIG. 1). The apparatus 10 for the middle (second) finger of the left hand includes numeral “3” on surface 17 (instead of the numeral “3” shown in FIG. 2) and includes the letter “D” on base 11 (instead of letter “L” shown in FIG. 1). The apparatus 10 for the index (first) finger of the left hand includes numeral “4” on surface 17 (instead of the numeral “3” shown in FIG. 2) and includes the letter “F” on base 11 (instead of the letter “L” shown in FIG. 1). The apparatus 10 for the index (first) finger of the right hand includes numeral “5” on surface 17 (instead of the numeral “3” shown in FIG. 2) and includes the letter “J” on base 11 (instead of the letter “L” shown in FIG. 1). And so on. The numbers or letters formed on surface 17 and base 11 can comprise in whole or in part an object associated with a selected theme.

The apparatus 10 for each finger is mounted on the top of that finger using mounting member 20 or some other means for securing apparatus 10 on each finger. The cover 12 of each apparatus 10 is closed. If the invention apparatus 10A is utilized, each apparatus 10A often can be simply laid on the top 26 of its associated finger.

The user's fingers are placed on a keyboard on what the user believes to the correct home keys associated with the fingers. After the user has placed his fingers on what are believed to be the correct home keys, the user opens each cover 12 to be certain that the user's fingers are on the correct home keys. If, for example, the user opens the cover 12 of the apparatus on the little finger of the left hand, he sees the letter “A”. If the little finger of the user's left hand is on the keyboard key labeled “A”, then the user's little finger is on the correct home key. If the little finger of the user's left hand in on the keyboard key labeled “S”, then the little finger is on the incorrect home key, and the user moves the little finger of his left hand to the “A” key on the keyboard. The user repeats this procedure for the apparatus 10 on each of the other fingers of the user's hands. After a while, the user automatically knows where to place his fingers to be on the correct home keys. The user may not, however, know what other keys of the keyboard are controlled and depressed by each of his fingers after the fingers are positioned on the correct home keys. Indicia 14 and 15 help the user in this regard by indicating other indicia which can be controlled by a finger. Indica 14 and 15 can indicate keys above or below a home key.

Having described my invention in such terms as to enable those of skill in the art to make and practice it, and having described the presently preferred embodiments thereof, I claim:

1. A method for learning the operation of a computer, the computer including a keyboard and a visual display operatively associated with the keyboard, the method including the steps of
(a) selecting a theme;
(b) selecting objects each directly associated with the theme;
(c) mounting on each finger of a user's hand label means including a picture of a different alphanumeric character drawn with one of the objects integrated with the alphanumeric character, each alphanumeric character being imprinted on one of the keys of the keyboard;
(d) placing each of the user's finger's on the keyboard on the key with the alphanumeric character corresponding to the alphanumeric character drawn on the label means on the finger;
(e) depressing with each finger the key on which the finger is resting to produce on the visual display the alphanumeric character associated with the key.

2. In combination with a finger of a user, apparatus for learning the operation of a computer, the computer including a keyboard and a visual display operatively associated with the keyboard, the keyboard including home keys, the apparatus including
(a) a base;
(b) fastening means on the base removably mounting the base on the user's finger;
(c) indicia means on the base identifying the home key of the selected finger;
(d) cover means attached to the base for concealing the indicia means from view and having at least two operative positions,
a first operative closed position for concealing the indicia means from view, and,
a second operative open position for exposing the indicia means to view.

3. A method for learning the operation of a computer, the computer including a keyboard and a visual display operatively associated with the keyboard, the method including the steps of
(a) removably mounting on each finger of a user
(i) first indicia means identifying the home key of the selected finger, and
(ii) second indicia means identifying the selected finger;
(b) concealing on each finger the first indicia means from view;
(c) placing each of the user's fingers on a key on the keyboard; and,
(d) exposing visually the first indicia means on at least one of the fingers to determine if the finger is positioned on the home key associated with the finger.
